(19) United States
(12) Patent Application Publication
(10) Pub. No.: US 2011/0114404 A1
(43) Pub. Date: May 19, 2011

(54) POWER RIM SYSTEM

(76) Inventor: Hung-Fu LEE, Banchiau City (TW)

(21) Appl. No.: 12/621,900

(22) Filed: Nov. 19, 2009

(51) Int. Cl. B60K 1/02

(52) U.S. Cl. 180/65.51

(57) ABSTRACT

A power rim system of the present invention includes magnets located on a rim of a vehicle, and coils are located on a wheel axle of the vehicle corresponding to the position extending into the rim, thereby forming a rim motor configuration when the rim and the wheel axle are joined together. Moreover, the power rim system is equipped with a motor control unit (MCU) connecting accelerator, brake and gear signals, a power detector, and rim motor angle signals, as well as being used to establish an electrical connection between a rim motor and a storage battery. When the vehicle accelerator is actuated, then electric power of the storage battery is output to the rim motor, which drives and rotates the rim, the electric supply being stopped when braking; moreover, electric power produced from the rotating rim is input to the storage battery and stored.

### BACKGROUND OF THE INVENTION

(a) Field of the Invention

The present invention relates to a vehicle rim system, and more particularly to a power rim system which can be integrated with a traditional vehicle engine to enable reducing oil consumption, as well as enabling a vehicle to switch to electrically driven travel operation.

(b) Description of the Prior Art

It is well known that the countless number of traditional automobiles and motorcycles are some of the major global consumers of energy resources and contributors to carbon dioxide emission. However, at present, because practical conditions still prevent the replacement of all traditional automobiles and motorcycles within the near future, thus, under such restrictive conditions, gasoline-electric hybrid power systems have assuredly become the focus of attention of car companies and the field of environmental protection.

The greatest difference between existing gasoline-electric hybrid power systems of the prior art and traditional engine transmission systems primarily lies in the engine of the gasoline-electric hybrid power systems being integrated with an electrically operated motor and automatic engine start-stop device, as well as an engine transmission system. Accordingly, as the vehicle gradually starts, the engine of the vehicle is first in a flameout state, and the engine is started completely by electric power means, and only when the vehicle continues to pick up speed does initiation of the engine using gasoline power begin to enable acceleration of the vehicle

Obviously, structural configurations of gasoline-electric hybrid power engines and tradition gasoline engines are entirely different, and actual economic benefits make it unsuitable to equip existing automobiles and motorcycles with a gasoline-electric hybrid power engine to provide gasoline-electric hybrid power output functionality Hence, a substantial expenditure is incurred by consumers wanting to replace his existing traditional vehicle engine and convert his vehicle into a gasoline-electric hybrid vehicle. Furthermore, because manufacturing plants are also unable to manufacture the required gasoline-electric hybrid vehicles within a short time, thus, the anticipated effectiveness of promoting gasoline-electric hybrid vehicles is less than ideal.

### SUMMARY OF THE INVENTION

In light of the above, the primary objective of the present invention is to provide a power rim system which can be integrated with a traditional vehicle engine to enable reducing oil consumption, as well as enabling a vehicle to switch to electrically driven travel operation.

In order to achieve the above objective, the power rim system of the present invention comprises a plurality of magnets annular disposed on a rim of a vehicle, thereby enabling forming a rotor portion of a motor. In addition, coils used to produce magnetic lines of force are located on a wheel axle of the vehicle corresponding to the position extending into the rim, thereby enabling forming a rim motor configuration when the rim and the wheel axle are joined together. Moreover, the power rim system is equipped with a motor control unit (MCU) that is used to connect accelerator signals, brake signals, gear signals, and rim motor angle signals of a vehicle with a power detector, as well as being used to establish an electrical connection between the rim motor and a storage battery.

Accordingly, under the integrative operation of the motor control unit (MCU), when the accelerator is actuated, then electric power of the storage battery is output to the rim motor, and oil consumption is decreased by using electric power to drive and rotate the rim. In addition, when a vehicle is coasting or braking and decelerating, not only is the storage battery stopped from supplying power to the rim motor, but also electric power produced from kinetic energy from rotary inertia of the rim is input to the storage battery and stored.

A first feature of the present invention lies in only requiring the wheel axle of a traditional vehicle engine to be re-equipped, and after replacing the rim and integrating with the motor control unit, then the function of enabling electric power to be used to drive and rotate the rim is effected, thereby improving the motive power of the vehicle as well as reducing oil consumption, or when the vehicle is in a low speed state, then only electric power is enabled to drive and rotate the rim to effect travel operation of the vehicle.

A second feature of the present invention lies in the entire power rim system, when the vehicle is coasting or braking and decelerating, being able to not only stop the storage battery from supplying power to the rim motor, but also enabling electric power produced from kinetic energy from rotary inertia of the rim to be input to the storage battery and stored, thereby achieving the effectiveness of energy recovery.

A third feature of the present invention lies in the motor control unit being further connected to external power sources, such as solar panels or wind driven generators, thereby enabling the entire power rim system to effect continuous charging of the storage battery both when the vehicle is traveling normally or in a stationary state by functioning in coordination with installed solar panels or wind driven generators.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a block schematic view depicting a combination structure of the present invention.

FIG. 2 is an exploded structural view of a rim motor according to the present invention.

### DETAILED DESCRIPTION OF THE PREFERRED EMBODIMENTS

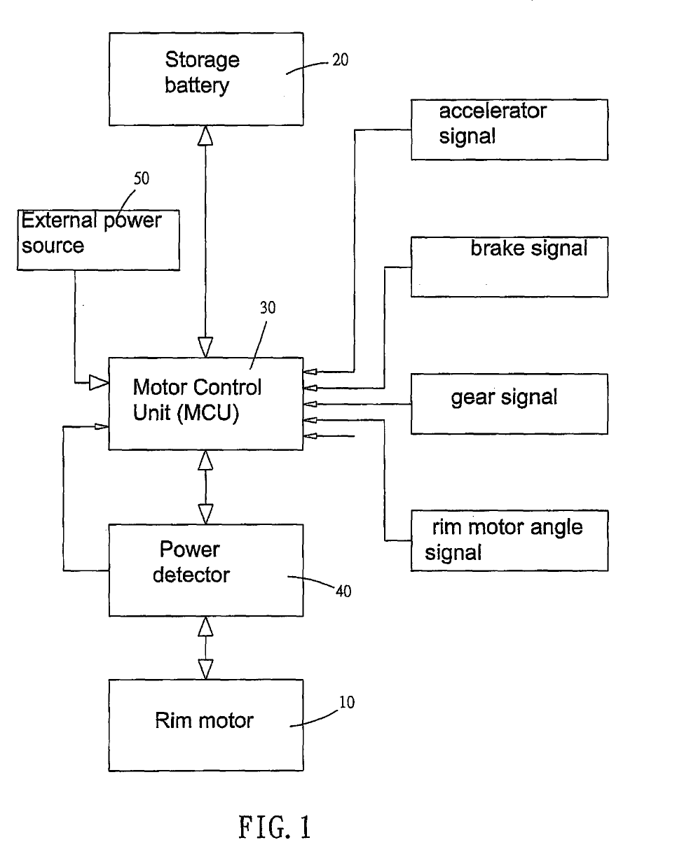

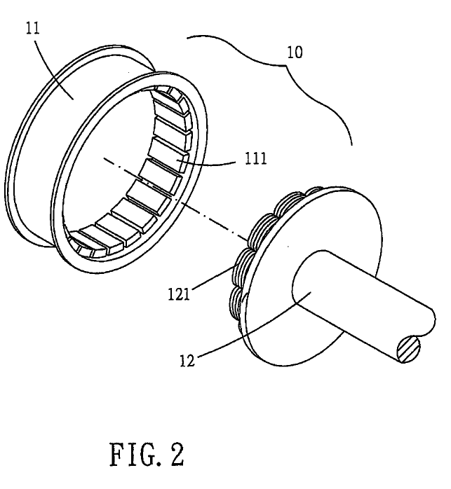

Referring to FIG. 1 and FIG. 2, which show a power rim system of the present invention comprising: at least one rim motor set 10, at least one storage battery 20, and a motor control unit 30 (MCU). In which:

The at least one rim motor set 10 is equipped with a plurality of magnets 111 annular disposed on a rim 11 of a vehicle, thereby enabling forming a rotor portion of a motor. Moreover, coils 121 used to produce magnetic lines of force are located on a wheel axle 12 of the vehicle corresponding to the position extending into the rim 11 (such as the wheel axle end), thereby enabling forming the rim motor set 10 configuration when the rim and the wheel axle are joined together.

The at least one storage battery 20 is used to provide the electric power required by the at least one rim motor set 10 to operate, as well as being used to store electric power produced by the at least one rim motor set 10 when rotating, while the motor control unit 30 (MCU) is used to connect accelerator signals, brake signals, gear signals, and rim motor angle signals of a vehicle with a power detector 40, as well as being used to establish an electrical connection between the rim motor set 10 and the storage battery 20.

During implementation, the entire power rim system can analyze accelerator signals and brake signals of the vehicle through means of sensing the rim motor accelerator angle and through means of sensing the brake angle. Moreover, rotation angle and speed of the rim 11 can be controlled by functioning in coordination with Hall components internally equipped to the rim motor 10 and used to sense magnetic forces.

Accordingly, the wheel axle of a traditional vehicle engine need only be re-equipped with the power rim system of the present invention, the re-equipping being completed by replacing the rim and integrating with the motor control unit 30. Under the integrative operation of the motor control unit 30 (MCU), when the accelerator is actuated, then electric power of the storage battery 20 is output to the rim motor 10, and rotation direction of the rim 11 of the rim motor 10 is controlled by functioning in coordination with a gear signal obtained. Oil consumption is decreased by using electric power to drive and rotate the rim 11, thereby improving motive power of the vehicle as well as reducing oil consumption. In addition, when a vehicle is coasting or braking and decelerating, not only is the storage battery 20 stopped from supplying power to the rim motor 10, but also electric power produced from kinetic energy from rotary inertia of the rim 11 is input to the storage battery 20 and stored, thereby achieving the effectiveness of energy recovery.

It is worth mentioning that the power rim system of the present invention is applicable for re-equipping to traditional automobile gasoline engines or traditional motorcycle gasoline engines. Moreover, the entire power rim system enables an electric generator of the vehicle itself to charge the storage battery 20 when the vehicle engine is running. Furthermore, the motor control unit 30 can be further connected to at least one external power source 50, and the external power source 50 can be a solar panel or wind driven generator, thereby enabling the entire power rim system to effect continuous charging of the storage battery both when the vehicle is traveling normally or stationary by functioning in coordination with the installed solar panel or wind driven generator.

According to what has been described above, the present invention provides a better and practicable power rim system. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A power rim system, comprising:
at least one rim motor set, the at least one rim motor set is equipped with a plurality of magnets annular disposed on a rim of a vehicle to enable forming a rotor portion of a motor, in addition, coils used to produce magnetic lines of force are located on a wheel axle of the vehicle corresponding to the position extending into the rim;
at least one storage battery, the at least one storage battery is used to provide the electric power required by the at least one rim motor set to operate, as well as being used to store electric power produced by the at least one rim motor set when rotating;
a motor control unit (MCU), the motor control unit (MCU) is used to connect accelerator signals, brake signals, gear signals, and rim motor angle signals of a vehicle with a power detector, as well as being used to establish an electrical connection between the rim motor and the storage battery; and
under integrative operation of the motor control unit (MCU), when the vehicle accelerator is actuated, then electric power of the storage battery is output to the rim motor, and the electric power is used to drive and rotate the rim; in addition, when a vehicle is coasting or braking and decelerating, the storage battery stops supplying power to the rim motor, and electric power produced from kinetic energy from rotary inertia of the rim is input to the storage battery and stored.

2. The power rim system according to claim 1, wherein the at least one rim motor set is internally equipped with Hall components used to sense magnetic forces to control the rotation angle and speed of the rim.

3. The power rim system according to claim 1, wherein the motor control unit (MCU) is further connected to at least one external power source.

4. The power rim system according to claim 3, wherein the external power source is a solar panel.

5. The power rim system according to claim 3, wherein the external power source is a wind driven generator.
